(19) United States
(12) Patent Application Publication
(10) Pub. No.: US 2014/0250466 A1
(43) Pub. Date: Sep. 4, 2014

(54) METHOD AND SYSTEM OF IDENTIFYING AND PROVIDING INFORMATION ABOUT PRODUCTS CONTAINED IN AN AUDIOVISUAL PRESENTATION

(71) Applicant: INPLACE MEDIA GMBH, Berlin (DE)

(72) Inventors: Patrick Lieberkühn, Berlin (DE); Nicholas Wittstruck, Wallenhorst (DE)

(73) Assignee: INPLACE MEDIA GMBH, Berlin (DE)

(21) Appl. No.: 13/784,472

(22) Filed: Mar. 4, 2013

(51) Int. Cl. H04N 21/478

(52) U.S. Cl. CPC H04N 21/47815
USPC 725/60

(57) ABSTRACT

The present invention regards a method and a system that allow the viewer of an audiovisual presentation such as a TV program or a movie to receive information about specific products or events of a scene of such audiovisual presentation. According to an embodiment, products or events contained in a scene of the audiovisual presentation and information about such products or events are stored in a database and provided to a device associated with the viewer. Other aspects of the invention regard a software implemented method of product positioning in an audiovisual presentation and a software implemented method for collecting information about products to be used in an audiovisual presentation,

### FIELD OF THE INVENTION

The present invention regards a method and a system that allow the viewer of an audiovisual presentation such as a TV program or a movie to receive information about specific products or events of a scene of such audiovisual presentation, e.g., by means of a software application on a smartphone or other intelligent communication device, and further allow the viewer to use the received information on such products or events for further interaction such as buying an identified product or learning more about the event.

Other aspects of the invention regard a software implemented method of product positioning in an audiovisual presentation and a software implemented method for collecting information about products to be used in an audiovisual presentation.

### BACKGROUND OF THE INVENTION

Document US 2012/008821 A1 discloses a video visual and audio query system for quickly identifying video within a Large known corpus of videos being played on any screen or a display. The system may record via a mobile phone camera and microphone a live video clip from the TV and transcode it into a sequence of frame-signatures. The signatures representative of the clips can then be matched against the signatures of the TV content in a corpus across a network to identify the correct TV show or movie.

Also, technology to identify a scene in a TV program or movie or related material is provided by US company TvTak located in New York, N.J. 10010. TvTak provides software allowing viewers to point their smartphone or tablet computer at the television screen and identify the shown program.

There is a need for methods and systems that use the known technology of identifying a TV program or movie while watching it to create or enhance services for the viewer and for the producer of a TV program or movie.

### SUMMARY

In one embodiment, the invention provides for a method of identifying and providing information about products contained in an audiovisual presentation that comprises a plurality of scenes, The method comprises: identifying by a device associated with a viewer of an audiovisual presentation a scene of the audiovisual presentation shown on a screen; identifying in a database products contained in the identified scene or contained in another scene of the audiovisual presentation, and further identifying in the database information about such products, wherein products and information about such products are stored in the database together with scene information regarding the scene or scenes in which the products are included in the audiovisual presentation; arid providing to the device associated with the viewer a list of identified products together with identified information about the products.

The information about an identified product may include information about a webstore selling the product to allow the user to instantly purchase or gather further information about the product. The device associated with the viewer may be a mobile telecommunications device such as a smartphone or a tablet computer, or may be a Smart TV, a Set-Top-Box, or a laptop, etc. A scene may be identified by means of at least one of audio detection and video detection.

In an embodiment, after identification of the scene of the audiovisual presentation, a plurality of scene identifiers of the audiovisual presentation is provided to the device. Upon selection of a particular one of the scene identifiers by the viewer, a list of identified products of that particular scene together with identified information about these products is provided to the device. Such scene identifier may be a still image of the respective scene., Such still image is also included in the database.

The information about a product may include at least one of the following: at least one photograph of the product, information on the manufacturer of the product, information about the price of the product, information about an actor wearing the product; and information on at least one sales point of the product. The audiovisual presentation may be a television program, a movie or related material. The products may comprise clothes, make-up, jewellery, furniture, electronic equipment and/or accessoires.

In one embodiment, the invention provides for a method of providing information about events contained in an audiovisual presentation that comprises a plurality of scenes. The method comprises: identifying by a device associated with a viewer of an audiovisual presentation a scene of the audiovisual presentation shown on a screen; identifying in a database events contained in the identified scene or contained in another scene of the audiovisual presentation, and further identifying in the database information about such events, wherein events and information about such events are stored in the database together with scene information regarding the scene or scenes in which the events are included in the audiovisual presentation; and providing to the device associated with the viewer information about the identified events.

This aspect of the invention differs from the first mentioned aspect in that information not about products, but about events is provided to a viewer. An event of a scene may be a dinner in a restaurant. The information about that event may include the name and location of the restaurant, and the recipe of the food that is eaten in that restaurant. Another example of an event is a hairwash and a haircut at a hairdresser. The information about that event may include the shampoo arid conditioner that is used and information about the specific hair cut.

In a further embodiment, the invention provides for a system of identifying and providing information about products contained in an audiovisual presentation that comprises a plurality of scenes, the system comprising: a mobile telecommunications device associated with a viewer of an audiovisual presentation; and a database containing products and information about products of audiovisual presentations, wherein products and information about products are stored in the database together with scene information regarding the scene or scenes in which the products are included in an audiovisual presentation; wherein the mobile telecommunications device includes an application software which is configured to identify a scene of the audiovisual presentation shown on a screen; and wherein the mobile telecommunications device and the database are configured to exchange information such that there is provided to the mobile telecommunications device a list of products together with information about the products that are contained in the identified scene or in another scene of the audiovisual presentation.

In a further embodiment, the invention provides for a system of identifying and providing information about events contained in an audiovisual presentation that comprises a plurality of scenes, the system comprising: a telecommunications device associated with a viewer of an audiovisual presentation; and a database containing events and information about events in an audiovisual presentation, wherein events and information about events are stored in the database together with scene information regarding the scene or scenes in which the events are included in the audiovisual presentation; wherein the telecommunications device includes an application software which is configured to identify a scene of the audiovisual presentation shown on a screen; and wherein the telecommunications device and the database are configured to exchange information such that there is provided to the telecommunications device information about the events that are contained in the identified scene or in another scene of the audiovisual presentation.

In a further embodiment, the invention provides for a software implemented method of product positioning in an audiovisual presentation, wherein at least one product is offered by the manufacturer of the product by means of a software application to a producer of audiovisual presentation for use in the audiovisual presentation; wherein the producer inspects the at least one offered product and selects at least one of the offered products by means of the software application; wherein the manufacturer or any other third party (e.g., a webstore or a third party database) provides information about a selected product including a photograph for each selected product by means of the software application; and wherein the at least one selected product and the information about the product is stored in a database.

In a further embodiment, the invention provides for a software implemented method for collecting information about products to be used in an audiovisual presentation of a TV or movie production, the method comprising: choosing by means of a software application a scene of an audiovisual presentation, and choosing by means of a software application products to be included in the chosen scene, wherein the products are chosen from a database that includes information about products already present and available at the TV or movie production site and about products that may be ordered from a manufacturer.

### BRIEF DESCRIPTION OF THE DRAWINGS

FIG. 1 illustrates an embodiment of a method that identifies and provides information about a product contained in a scene in a television program or movie, wherein the method allows interaction of the viewer with respect to products contained in an identified scene;

FIG. 2 illustrates examples of potential interactions of a viewer with respect to products identified by the method illustrated in FIG. 1;

FIG. 3 illustrates a sequence of steps to gather information about products used in scenes of a TV program or movie by the producer of such TV program or movie;

FIG. 4 illustrates the content of a database that is used in the method illustrated in FIG. 1 in one embodiment; and

FIG. 5 illustrates method steps carried out by a smartphone or tablet software application to aid a set designer in assigning clothes to actors in scenes of a TV production or movie and store such assignment information in a database.

### DETAILED DESCRIPTION

The following description of embodiments of the present invention includes the description of more abstract embodiments which are described without referring to the

FIG.s and includes the description of more concrete embodiments which are described by referring to the FIG.s. The more abstract embodiments are described first.

Generally, in the following description of embodiments of the present invention the expressions “first party”, “second party”, “third party” and “fourth party” encompass the following meanings. The first party is the producer of a television (TV) program or of a movie or of any other related material such as advertisements. Such television program, movie or related material represents audiovisual information and will in the following be referred to simply as TV program.

The expression second party refers to the manufacturer of any product or item suitable to be included in a scene of a TV program. The second party could be, e.g., the manufacturer of clothes, of shoes, of cosmetics, of furniture, of electronic equipment, of jewellery or the manufacturer of accessories. The third party is the viewer of the TV program. Such TV viewer may also be referred to as the consumer or as the user. The fourth party is the seller or retailer who sells the second party's goods. if the second party directly sells its products, the fourth party may be identical with the second party.

One kind of TV program of particular interest in respect of the present invention is a TV show such as a sitcom. However, the principles of the present invention apply similarly to any other television program such as news shows, movies, documentary films, advertisements, etc. Also, although referring to TV programs and movies, such programs and movies may be viewed or shown not on a television or on a theatre screen, but on a smartphone, tablet computer, personal computer, and the like.

A first more abstract embodiment regards a software application (“App”) installed by a third party (the viewer of a TV program) on his smartphone or tablet computer. The software application is configured to aid in carrying out the following steps:
The third party watches a television program and sees a product he is interested in.
The third party uses the App installed on its mobile phone, tablet PC, etc.
Audio detection and/or image recognition are used by the App to identify the television program, and the current scene in the television program. To this end, a part of the scene (video and/or audio) is recorded by the application, analyzed and compared to a data base.
In an embodiment, a time is identified at which the recorded part is shown. The information (TV program and time in the TV program) is compared to a further database related to the TV program in which time in the TV program and scene are correlated; in this way the scene of the TV program may be identified. However, other ways of identifying a scene are also possible. For example, analyzing the recorded part of a scene may provide for a specific signature that is assigned in a data base to a specific scene.
Once the scene is identified a central database is used to identify the items shown in the scene.
The App provides a list of scenes to the third party, the scene that comprises the recorded part is specifically labelled.
The third party can choose the scene he was initially interested in or any other scene of the TV program.
For each scene photos of the respective items saved in the central database can be shown to the third party.
Once the App has identified the TV program, the third party can check products in other scenes without the need to identify the TV program again.
Each product is linked to an online shop operated by the fourth party allowing the third party to buy the product.
Several online shops can also be proposed per product.
The third party can give comments to the products displayed and can see comments of other users of the App.
The third party can use the App without an account but can also create an account.
The App registers how often the account holder uses the App and how often he buys a product.
All products sold by using the App are registered. The fourth party pays a fee for each sold product to the first party.

A second more abstract embodiment regards an application software used by a second party and a first party, Some or all of the following steps may be implemented:
The second party offers products and bids for a sum/time unit that the second party would pay to the first party if the product is shown in the television program.
The second party can choose the television program in which the product shall be placed, even the actor.
The second party gets information about the number of TV viewers (third party) of the different television programs.
The second party can see the total of his own products offered.
The second party leaves offers in the browser until the first party has selected the offer or until the second party cannot provide the product anymore.
All offers are saved in a central database for the specific television program.
The offers can be repeated for another television program, the offers will then be saved in a different central database.
The second party provides reference of the product, a description of the product and a photo of the product.
The first party can choose among the different offers of the different second parties.
In case that two offers of two different second parties are very similar (in design), the first party chooses the offer with the higher bid.
The chosen product is sent to the first party and becomes part of the fund.
Only if the product is really shown in the television program, the second party pays the bidden sum/time unit.
The first party can directly ask for specific objects required for a scene, so that the second party can respond directly to the demand.
If second party does not only produce the items but also sells them to the public, the second party can also bid for being placed as seller in the App used by the third party.

A third more abstract embodiment regards a software used by the first party. The software is an organization tool of a TV set or Movie set designer. The software is configured to allow defining some or all of the following steps:
The set designer defines the actors' clothes and actors' accessories in a specific scene.
The set designer indicates scene (television program, scene number (correct scene number can be added later) and the days of shooting the scene,
The set designer takes a photo of each actor showing the make up and the hairstyle.
The set designer selects an outfit for an actor and looks for adapted clothes in the central database or buys adapted clothes and adds them to the database (if applicable in combination with the actor's name).
In this respect, the set designer may make a photo of a product and store it in the database. He may also try to find the product in a webstore and link it to such webstore.
The set designer can only see offers and elements of the fund that are not already assigned to another actor and in particular elements of the fund that are assigned to the actor that shall be clothed,
The set designer has a virtual dress-up doll to check different combinations of clothes.
The set designer saves per actor the clothes, accessoires, make-up products.
The set designer also indicates where (location) to find the objects/clothes.
If it appears (for example during shooting) that for any reason the chosen clothes are not suited, the choice can be changed and saved again.
Each set designer has an account, possibility to authorize access only to specific scenes in a television program, only to specific television programs.

A fourth more abstract embodiment of the invention regards a central catalogue to be used by the first party. The central catalogue:
may comprise offers of the second party and elements of the fund (accepted offers or elements that have been added independently from the offers):
can further comprise personal clothes of the actors (to add personal clothes a photo is taken and saved with the actor's name: assignment is made immediately, clothes are not available for other actors): and
can further comprise elements of the fund that are linked with the information who is wearing a specific piece of clothing, one piece of clothing is being assigned to two or more actors;
Products may be categorized in clothing, cosmetics, furniture, electronic equipment, jewellery, accessoires.
Clothing may be categorized in type of cloth; male-female, child-adult, season, size.

The invention will next be described with respect to more concrete embodiments.

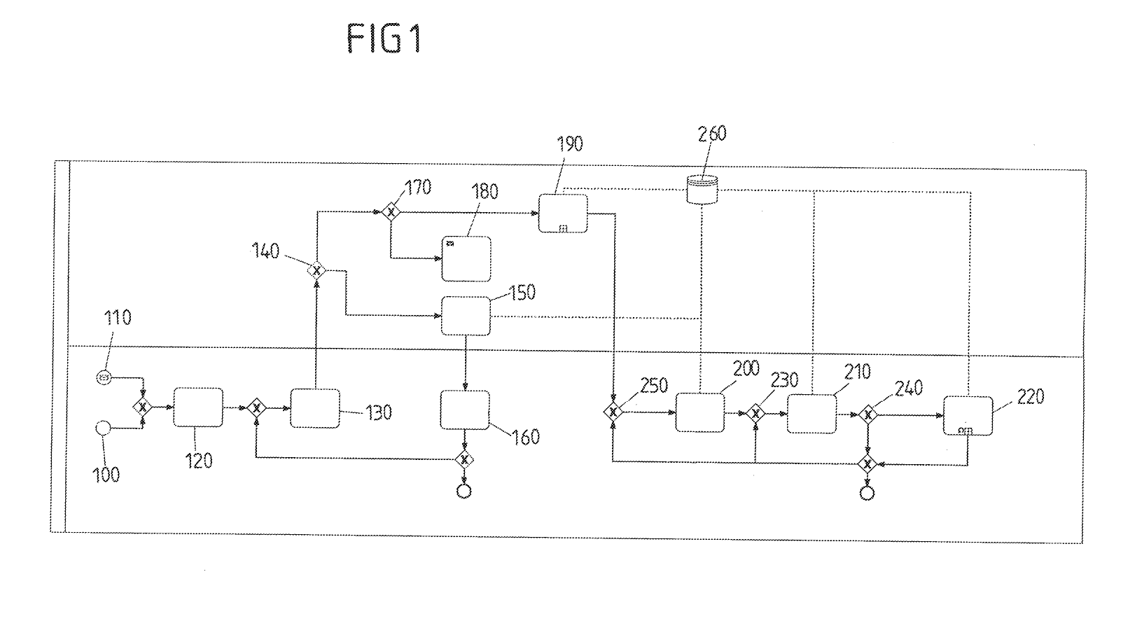

FIG. 1 illustrates the steps carried out by a viewer in conjunction with a software application stored in a smartphone, tablet computer, Smart TV, Set-Top-Box or laptop or similar device of the viewer to identify and interact with items or products of scenes of a TV program. The typical starting, point for the procedure is represented by the situation that the viewer of a TV program is interested in a product shown in a scene of that TV program. For example, the TV program is a sitcom and the product is a particular piece of cloth that one of the actors is wearing in that scene. The TV program may be shown life or may have been recorded and be now played. This starting situation is identified by reference sign 100 in FIG. 1. Alternatively, in step 110, the viewer receives as a push message a message to his smartphone informing him about a particular show or about a particular product that is worn by a particular actor in a particular show. Typically, in such case, the viewer has previously indicated that he is interested in the show or in clothes being worn by a particular actor. In both scenarios 100, 110, the viewer opens in step 120 the respective application (“App”) on his smartphone. In the following, when referring to a smartphone, this shall imply reference also to a tablet computer or other communication device.

Once the application has been opened in step 120, the application implements a method to identify in step 130 the TV program that is viewed by the viewer. Such identification is carried out, e.g., by software modules and technology provided by the US company TvTak located in New York, N.Y. 10010.

If the TV program is not recognized by the application in branching point 140, an error message is created and send in step 150 over a communication network such as the internet to a person interested in that information, e.g., the producer of the application software, and indicated in step 160 to the viewer such that the viewer may try again in step 130 to identify the TV program.

Similarly, if a shown TV program is not recognized in branching point 170, a query 180 may be generated with the purpose to contact the producer of the TV program and call for a cooperation and information about the shown program.

In any case, when the program is identified, there is identification riot only as to the name of the shown program, but also with respect to the specific scene that is being shown. Accordingly, the application software assigns the part of the TV program that was analysed in step 130 to a specific scene of the TV program. Once such identification has been carried out, the following information is sent in step 190 to the smartphone by means of the application opened in step 120: First, a still image or a video frame of the identified scene is shown on the display of the smartphone. Second, a list of products included in the identified scene is shown on the display or may be viewed by scrolling the display. The product is shown together with metadata regarding the respective product.

For example, in addition to the product (i.e., a product identifier such as a product name), information may be provided including photos of the respective products and including information as to the manufacturer, the price and, in case the product shall be purchased, a link to a webshop selling the product. Further information may be added or further downloaded on request such as information about an actor wearing a particular piece of cloth.

In a further embodiment, there is provided to the viewer not only information about the scene currently viewed, but also about other scenes of the film. Accordingly, the viewer may choose to receive information about products of the scene he just viewed or of other scenes of the TV program.

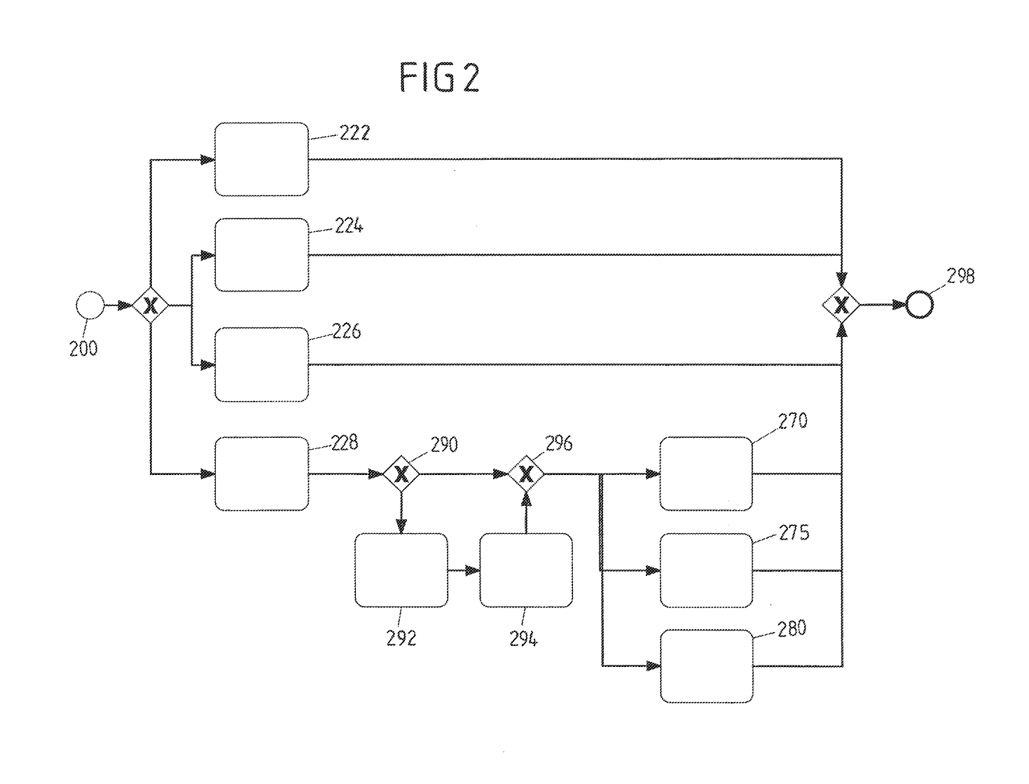

Accordingly, in step 200 the viewer chooses a particular scene for which he wishes to view and receive information about the products contained in that scene. In step 210, the viewer chooses to receive information about a particular product contained in the chosen scene. Once the product is chosen, particular kinds of product interaction 220 are available, as will be described with respect to FIG. 2.

If a scene is not chosen or a product is not chosen in branching points 230, 240, the program returns to branching point 250.

All interactions and user choices may be stored in a statistic database 260.

FIG. 2 illustrates potential product interactions, i.e. interactions of the user with respect to a chosen product. The product interactions described in the following are of exemplary nature only, and there may be provided less and/or different and/or additional user interactions, One possible user interaction is to comment on a chosen product, step 222. Such comment may be provided to an internet site listing comments on products. In step 224, the user may choose to provide a “like”-information expressing that he likes the shown TV program. Similarly, in step 226 the user may choose to provide “share”-information indicating that he recommends that others also view this TV program. Such “like”-information and “share”-information may be provided over a social network to friends of the viewer.

In case that the viewer is interested in buying the identified article, he then presses a button to open in step 228 a link to a webshop in which the specific item is sold. He may then choose in step 270 to buy the product, in step 275 to buy further products or in step 280 to not to buy the product. In branching point 290, the user may effect that the URL of the webshop is sent to his desktop computer, step 292, in which case he will do the shopping from his desktop, step 294, which may be more convenient than doing the shopping from the smartphone or tablet. Accordingly, the website of the webshop is opened in step 294 by the desktop computer who then connects to the webshop containing the product in step 296 to buy the product, to buy further products or not to buy the product, steps 270, 275, 280. The process ends in step 298.

The invention as described with respect to FIGS. 1 and 2 enables a viewer of a TV program to identify a specific product or item shown in a scene of that TV program, receive information about that product or item and interact with such a product or item, i.e., by commenting or buying it.

In order to provide such method, it is necessary that a database is built up that includes information about the different items included in different scenes of a TV program and metadata about the individual items, such as information about the manufacturer, quality, material, price, availability, retailer, website of retailer, etc.

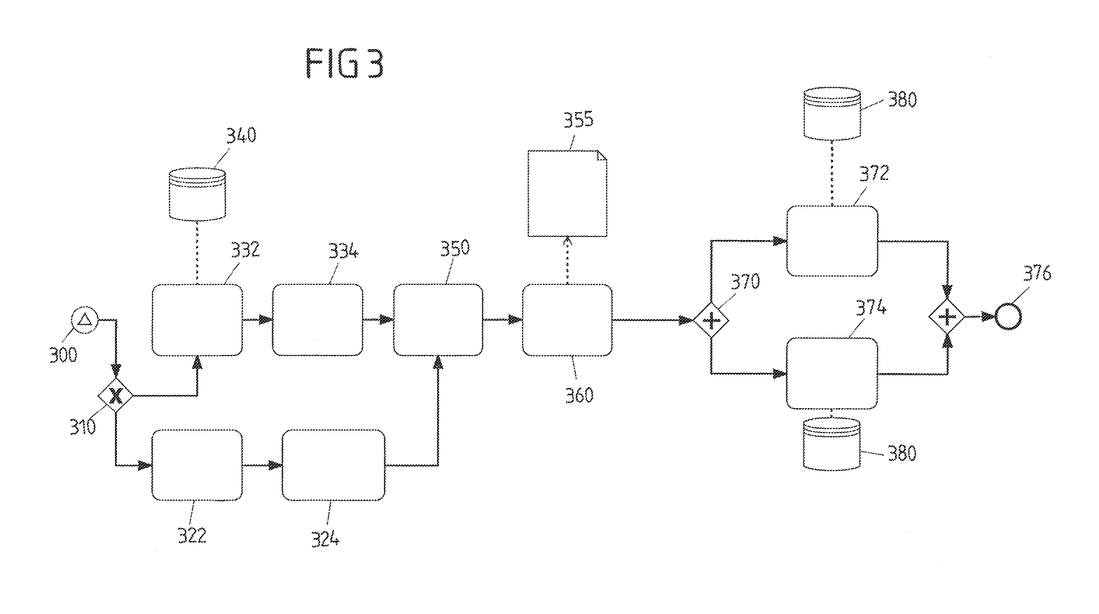

The building up of such database is described by example with respect to FIG. 3. The starting point 300 is the conception of a particular scene of a particular TV program, wherein such conception includes the definition of particular items that shall be present in the scene, The particular items/products of a scene may be products worn by particular actors of the scene or other products such as furniture, electronic equipment or pieces of art.

In branching point 310, the producer (i.e., a person working for the producer) has to decide for each product of whether he buys the product such as a piece of cloth by himself or has the item delivered by a manufacturer or related person of the product. If he decides to buy the product by himself, step 322, he then stores metadata of the bought product in step 324 in a database. The metadata may include at least one photo of the product, information about the shop were the product was acquired, information about the manufacturer, about size, about where the product is located at the premises of the producer, etc.

Alternatively, if the producer does not decide to buy the product in step 310, he picks the product that he wishes to use in a specific scene from a catalogue 340 available to him, step 332. Once he has chosen a product from the catalogue 340, the product is then shipped to him from the manufacturer, step 334, If the product is chosen from catalogue 340, metadata about the product included in the catalogue are automatically stored in the mentioned database.

If the product is chosen from catalogue 340, there are several ways of how a specific product is included in catalogue 340. In one embodiment, the producer has agreed with a particular manufacturer or fashion house that the manufacturer or fashion house provides particular articles for particular TV programs. In such case, photos of the respective products and their sizes, if applicable, are provided by the manufacturer or fashion house and stored in the catalogue. In another embodiment, an item is included in the catalogue depending on the results of a placement bid by several manufacturers, as was described above in connection with the second more abstract embodiment.

Subsequently, the product is used in the particular scene, step 350. For example, if the product is a pair of shoes, the pair of shoes is assigned to a specific actor of the specific scene and worn by that actor in that scene. In another example, if the product is a carpet, that carpet is used in that particular scene.

Once the scene has been taken, additionally information e.g. about actors who wore the product or about the particular scene and possibly further metadata are stored in the database, step 360. To store these data in the database, a separate software application 355 run on a smartphone or tablet computer may be used.

After the respective scene has been finalized and cut, step 370, two further kinds of information are stored in the database. First, in step 372, one or several still images of the respective scene are identified and stored in a scene storage of the data base 380. These still images are stored for the purpose of sending a still image of the scene identified by a viewer to the viewer's smartphone or tablet computer together with information about the products contained in the scene, see step 190 in FIG. 1.

Further, in step 374, a code identifying the scene is stored together with the metadata about the products in database 380. The code identifying a scene may be a time code or any other code identifying different scenes of a TV program, movie, etc.. The process of FIG. 3 ends in step 376.

The data base 380 thus includes data identifying the products (such as a product's name), metadata about the products, and scene information, wherein the product and the metadata and assigned to one or several scenes, such that by identifying a scene, the products included in the scene and metadata about these products can be identified in the database 380. The database 380 may include further information such as information about actors wearing or using the products.

Accordingly, the database 380 contains information linking specific products and information about these products to specific scenes. This is important because the viewer in step 130 of FIG. 1 recognizes a specific scene of the TV program and in step 200 of FIG. 1 is able to choose between different scenes of the particular TV program. Therefore, the required information about products and items contained in a scene must be linked to the scene.

The database 380 may be organized in any, known way, It may me present at a central location or be organized on a plurality of computers.

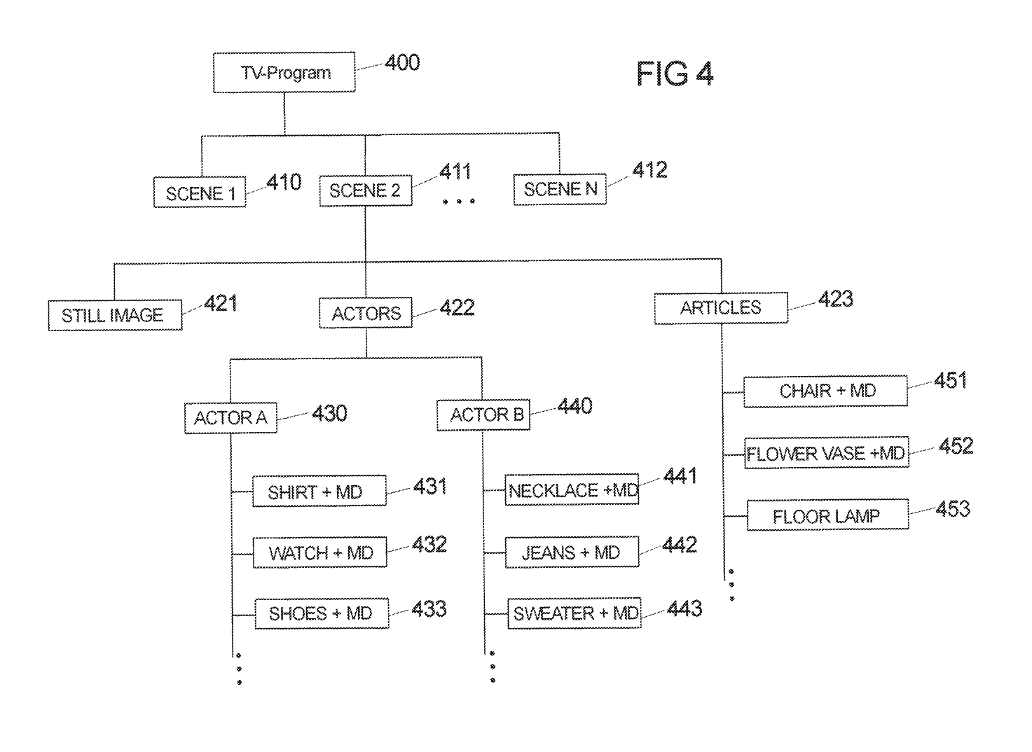

FIG. 4 shows in an embodiment the organization of a database to be used in the process of FIG. 1 to provide product information about a product of a scene of a TV program identified by the viewer's software application. In the embodiment of FIG. 4, the database includes information about a plurality of TV programs, such as TV program 400. For TV program 400, there is contained in the database information about a plurality of scenes 410, 411, 412. A scene typically comprises action in a single location and in continuous time.

In the following, a further look is taken at the information stored for scene 411. Similar information is stored for the other scenes 410, 412. The information for scene 411 includes one or more still images 421 of the chosen scene 411, information 422 about actors that take part in scene 411, and information about articles 423 contained in the scene. Information 422 about actors may include information about actor A 430 and information about actor B 440 in the shown example. Of course, there may be stored information about further actors. The information about actor A may include information about the shirt 431, the watch 432 and the shoes 433 actor A is wearing in scene 411. The information about actor B may include information about the necklace 441, the jeans 442 and the sweater 443 actor B is wearing in scene 411. Of course, information about additional items that actor A or Actor B or other actors are wearing can further be included in the database, The information about the articles 423 contained in scene 411 may include information about a chair 451, information about a flower vase 452, and information about a floor lamp 453.

The information 431, 432, 433, 441, 442, 443, 451, 452, 453 is stored in combination with metadata (MD) for the respective products in each case. Accordingly, the information about the products is stored together with metadata information. The metadata information may include a photo of the product, information about the manufacturer of the product, a retailer selling the product, a website of the retailer, price information, and other information that may be of interest to the viewer interested in the respective product. Such additional information may include other actors that wear or like this product, or quality reports, etc.

In a further embodiment, the database additionally includes metadata about the respective products which are not of importance to the viewer, but to the producer. Such information may include, e.g., information of whether and where a product is stowed at the premises of the producer, or information about from whom the product was bought or received, or information about other scenes and actors in which the product is used or shall be used. Further, the catalogue information of catalogue 340 of FIG. 3 may also be included in the database.

In a further embodiment, the database may also include metadata about events in particular scenes. For example, an event in a scene could be defined and information be assigned to such event. For example, if the event is a dance, information about the music and the dance style may be stored. If the event is a visit of a bar, the kind of drinks served at the bar may be stored. This way, information about events in a scene may also or alternatively be provided to the viewer.

The database structure shown in FIG. 4 is of exemplary nature only and serves to illustrate the kind of information contained in the database. The way in which this information is organized and how specific pieces of information are linked and assigned to each other is not of relevance and may be done in accordance to any known database technologies.

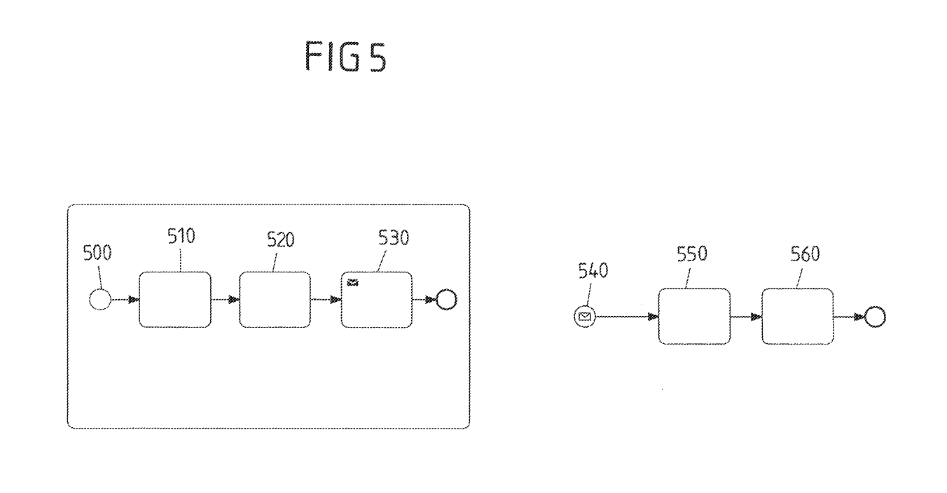

FIG. 5 describes the steps carried out by an application software stored on a smartphone or a tablet PC or the like to be used by set designer in order to gather and store data in a databank that refer to the choosing and assigning of specific products to specific scenes of a TV program. These data may or may not be stored together with the data of the database of FIG. 4. According to FIG. 5, in step 500, a costume designer opens an application on his smartphone or tablet regarding the storing of product information contained or desired at the premises of the producer. In step 510, the product designer chooses from a catalogue (not shown) a particular product to be used in a particular scene of a particular TV program. In step 520, he chooses a particular size of a product and assigns the product a specific function, such as to be worn by actor X in scene Y of TV program Z. In step 530, the product is ordered. Once the product has been received in step 540, the product is hung at a specific location at the wardrobe at the premises of the producer of some related company, and the location is stored in the application run on the smartphone or tablet, step 550. In step 560, the availability of the program is confirmed by the application. The above mentioned steps may be carried out in the sequence mentioned or in any other sequence.

A number of implementations of the present invention have been described. Nevertheless, it will be understood that various modifications may be made without departing from the spirit and scope of these implementations. For example, though some of the discussion has focused on information about products included in a TV program, similarly information about events in a TV program may be provided to the used in a similar manner. Accordingly, other implementations are within the scope of the following claims.

What is claimed is:

1. A method of identifying and providing information about products contained in an audiovisual presentation that comprises a plurality of scenes, the method comprising:
identifying by a device associated with a viewer of an audiovisual presentation a scene of the audiovisual presentation shown on a screen;
identifying in a database products contained in the identified scene or contained in another scene of the audiovisual presentation, and further identifying in the database information about such products, wherein products and information about such products are stored in the database together with scene information regarding the scene or scenes in which the products are included in the audiovisual presentation; and
providing to the device associated with the viewer a list of identified products together with identified information about the products.

2. The method of claim 1, wherein the information about an identified product includes information about a webstore selling the product to allow the user to instantly purchase or gather further information about the product.

3. The method of claim 1, further comprising providing a rating of or a comment on an identified product.

4. The method of claim 1, wherein the device associated with the viewer is a mobile telecommunications device such as a smartphone or a tablet computer, or a Smart TV or a Set Top Box or a laptop, or the like.

5. The method of claim 1, wherein a scene is identified by means of at least one of audio detection and video detection.

6. The method of claim 1, wherein, after identification of the scene of the audiovisual presentation, a plurality of scene identifiers of the audiovisual presentation is provided to the device, and wherein, upon selection of a particular one of the scene identifiers by the viewer, a list of identified products of that particular scene together with identified information about these products is provided to the device.

7. The method of claim 6, wherein a scene identifier is a still image of the respective scene, and wherein such still image is also included in the database.

8. The method of claim 1, wherein the information about a product includes at least one of the following:
at least one photograph of the product,
information on the manufacturer of the product,
information about the price of the product,
information about an actor or moderator or presenter wearing the product; and
information on at least one sales point of the product.

9. The method of claim 1, wherein the audiovisual presentation is a television program, a movie or related material.

10. The method of claim 1, wherein the products comprise at least one of clothes, make-up, jewellery, furniture, electronic equipment and accessoires.

11. The method of claim 1, wherein the method is carried out using a software application installed on the device associated with the user.

12. A method of identifying and providing information about events contained in an audiovisual presentation that comprises a plurality of scenes, the method comprising:
identifying by a device associated with a viewer of an audiovisual presentation a scene of the audiovisual presentation shown on a screen;
identifying in a database events contained in the identified scene or contained in another scene of the audiovisual presentation, and further identifying in the database information about such events, wherein events and information about such events are stored in the database together with scene information regarding the scene or scenes in which the events are included in the audiovisual presentation and
providing to the device associated with the viewer information about the identified events.

13. A system of identifying and providing information about products contained in an audiovisual presentation that comprises a plurality of scenes, the system comprising:
a telecommunications device associated with a viewer of an audiovisual presentation and
a database containing products and information about products of audiovisual presentations, wherein products and information about products are stored in the database together with scene information regarding the scene or scenes in which the products are included in an audiovisual presentation;
wherein the telecommunications device includes an application software which is configured to identify a scene of the audiovisual presentation shown on a screen;
and wherein the telecommunications device and the database are configured to exchange information such that there is provided to the telecommunications device a list of products together with information about the products that are contained in the identified scene or in another scene of the audiovisual presentation.

14. A system of identifying and providing information about events contained in an audiovisual presentation that comprises a plurality of scenes, the system comprising:
a telecommunications device associated with a viewer of an audiovisual presentation; and
a database containing events and information about events in an audiovisual presentation, wherein events and information about events are stored in the database together with scene information regarding the scene or scenes in which the events are included in the audiovisual presentation;
wherein the telecommunications device includes an application software which is configured to identify a scene of the audiovisual presentation shown on a screen;
and wherein the telecommunications device and the database are configured to exchange information such that there is provided to the telecommunications device information about the events that are contained in the identified scene or in another scene of the audiovisual presentation.

15. A software implemented method of product positioning in an audiovisual presentation, wherein:
at least one product is offered by the manufacturer of the product by means of a software application to a producer of audiovisual presentation for use in the audiovisual presentation;
the producer inspects the at least one offered product and selects at least one of the offered products by means of the software application;
the manufacturer or any other third party provides information about a selected product including a photograph for each selected product by means of the software application; and wherein
the at least one selected product and the information about the product are stored in a database.

16. The method of claim 15, wherein the manufacturer indicates by means of the software application an amount per time unit for each offered product the manufacturer is willing to pay in case that the offered product is placed in an audiovisual presentation by producer.

17. The method of claim 15, wherein the manufacturer indicates by means of the software application an amount the manufacturer is willing to pay for being indicated to viewers as sales point for purchasing the product placed in the audiovisual presentation.

18. The method of claim 15, wherein at least one retailer different from the manufacturer indicates by means of the software application an amount he is willing to pay for being indicated to viewers as sales point for purchasing the product placed in the audiovisual presentation,

19. The method of claim 15, wherein several manufacturers provide by means of the software application competing bids for similar types of products for use in the audiovisual presentation.

20. A software implemented method for collecting information about products to be used in an audiovisual presentation of a TV or movie production, the method comprising:
choosing by means of a software application a scene of an audiovisual presentation, and
choosing by means of a software application products to be included in the chosen scene,
wherein the products are chosen from a database that includes information about products already present and available at the TV or movie production site and about products that may be ordered from a manufacturer,

21. The method of claim 20, further comprising adding to the database at least one of the following:
information about the chosen scene in which the products are to be included;
photos of the products;
product sizes;
information about actors that shall wear the products;
a storage location;
information about events in a scene, and
availability of the products.

22. The method of claim 20, wherein the software application includes a virtual dress-up doll allowing a set designer to check different combinations of clothes.
